(19) United States
(12) Patent Application Publication
(10) Pub. No.: US 2026/0351450 A1
(43) Pub. Date: Nov. 5, 2026

(54) VARIABLE RESISTOR

(71) Applicant: Alps Alpine Co., Ltd., Tokyo (JP)

(72) Inventor: Takayuki FUJITA, Miyagi-ken (JP)

(21) Appl. No.: 19/649,575

(22) Filed: Apr. 16, 2026

(30) Foreign Application Priority Data
Apr. 24, 2025 (JP) 2025-072100

(51) Int. Cl. H01C 10/32

(52) U.S. Cl. CPC H01C 10/32

(57) ABSTRACT

A variable resistor includes a substrate; a resistance element disposed on the surface of the substrate and including carbon powder and a binder resin that binds the carbon powder; a conductive wiper that slides on the surface of the resistance element; and a lubricant applied to the surface of the resistance element. The lubricant has a molecular structure including a chain structure including a plurality of carbon atoms covalently bonded to each other. The chain structure has polar functional groups located at one end and the other end thereof. The number of hydrogen atoms bonded to the carbon atoms is greater than the number of fluorine atoms bonded to the carbon atoms.

### CLAIM OF PRIORITY

This application claims benefit of Japanese Patent Application No. 2025-072100 filed on Apr. 24, 2025, which is hereby incorporated by reference.

### BACKGROUND OF THE INVENTION

### 1. Field of the Invention

The present invention relates to a variable resistor used in a controller for a game machine or the like.

### 2. Description of the Related Art

In recent years, due to diversification of game operations, performance levels required for controllers such as analog joysticks used in game devices have been increasing. For example, an increase in the number of operable cycles of the controller by extending sliding life has been demanded.

A variable resistor that varies an output voltage in response to an operation is used in a controller for a game device. The variable resistor varies an output voltage in accordance with an electrical resistance value that changes as a conductive wiper, such as a metal slider, moves on (the surface of) a resistance element in response to an operation of the controller.

The resistance element on the surface of which the conductive wiper slides is a film (composite film) of a composite material of a resin and carbon powder. With an increase in the number of sliding cycles, the amount of wear at a contact portion in the resistance element increases. When the wear progresses, contact with the conductive wiper becomes unstable, thereby generating output noise. As a countermeasure against this output noise, a fluorine-based lubricant is applied to a sliding contact for the purpose of improving lubricity and reducing wear at a contact portion between the carbon resistance element and the conductive wiper (contact).

For example, Japanese Unexamined Patent Application Publication No. 2001-230104 describes a sliding resistance element (variable resistor) that is intended to ensure stable electrical conduction, exhibit excellent sliding resistance over a long period of time, and reduce the likelihood of occurrence of sliding noise. The sliding resistance element includes a resistance element disposed on a surface of a resistance element substrate and a contact that slides on the resistance element, and a lubricant layer composed of a fluorine-based lubricant is provided on the entire surface of the resistance element substrate on which the resistance element is disposed, or on at least a portion of the surface on which the contact slides. The fluorine-based lubricant of the lubricant layer has a carboxyl group or an isocyanate group at an end thereof, which forms a hydrogen bond with the resistance element and firmly adheres to the resistance element.

### SUMMARY OF THE INVENTION

A variable resistor that uses a fluorine-based lubricant as a lubricant layer between a carbon resistance element and a conductive wiper may not be capable of achieving an increase in the number of operable cycles by extending sliding life, which has been particularly strongly demanded in recent years.

The present invention provides a variable resistor that achieves an increase in the number of operable cycles by extending sliding life.

As means for solving the above-described problems, the present invention includes the following configuration.

A variable resistor including a substrate; a resistance element disposed on a surface of the substrate, the resistance element including carbon powder and a binder resin that binds the carbon powder; a conductive wiper that slides on a surface of the resistance element; and a lubricant applied to the surface of the resistance element, wherein the lubricant has a molecular structure including a chain structure including a plurality of carbon atoms covalently bonded to each other, the chain structure having polar functional groups located at one end and the other end thereof, a number of hydrogen atoms bonded to the plurality of carbon atoms being greater than a number of fluorine atoms bonded to the plurality of carbon atoms.

The surface of wear debris generated by repeated sliding of the conductive wiper on the surface of the resistance element is composed of carbon C, hydrogen H, and oxygen O. Accordingly, the lubricant in the variable resistor according to the present invention has a molecular structure in which the number of hydrogen atoms bonded to a plurality of carbon atoms forming a chain structure is greater than the number of fluorine atoms bonded to the carbon atoms. A lubricant having such a molecular structure has better wettability with respect to wear debris than a fluorine-based lubricant in which fluorine is bonded to a plurality of carbon atoms forming a chain structure and that has been used in the related art. Therefore, the wear debris is readily and uniformly dispersed in the lubricant, and even when wear debris is generated by repeated use, aggregation and thickening of the wear debris may be suppressed. Thus, thickening and aggregation of wear debris generated by sliding of the conductive wiper on the surface of the resistance element may be suppressed.

The polar functional groups may be hydroxyl groups.

The chain structure may have an oxygen atom in an intermediate portion other than the polar functional groups located at one end and the other end.

When the polar functional groups are hydroxyl groups and the chain structure has an oxygen atom in the intermediate portion, wettability of the lubricant with respect to the resistance element may be improved.

The lubricant may be polyalkylene glycol or a bonded product of a plurality of polyalkylene glycols. The lubricant may be polybutylene glycol. The lubricant may be polyalkylene glycol glyceryl ether. The lubricant may be polypropylene glycol glyceryl ether.

Noise caused by wear debris generated by sliding of the conductive wiper may be suppressed by the above-described lubricant having excellent wettability with respect to the resistance element.

The binder resin may have a hydroxyl group. The binder resin may be a phenolic resin.

Noise caused by wear debris generated by sliding of the conductive wiper may be suppressed by a binder resin having a hydroxyl group, such as a phenolic resin.

In the variable resistor according to the present invention, by using a lubricating oil having a molecular structure in which the number of hydrogen atoms bonded to carbon atoms is greater than the number of fluorine atoms bonded to the carbon atoms, thickening and aggregation of wear debris of the resistance element may be suppressed. Thus, when the conductive wiper is repeatedly slid on the surface of the resistance element, generation of noise caused by the wear debris may be suppressed, and a variable resistor in which the number of operable cycles is increased by extending sliding life may be provided.

### BRIEF DESCRIPTION OF THE DRAWINGS

FIG. 1 is a plan view of a variable resistor according to an embodiment of the present invention, schematically illustrating a main part;

FIG. 2 is a diagram schematically illustrating a cross section taken along line II-II in FIG. 1;

FIG. 3 is a diagram schematically illustrating a cross section of a known variable resistor in a state after repeated use;

FIG. 4 is a photograph substituted for a drawing, illustrating the surface of a conductive wiper in a known variable resistor in which a problem has occurred in operation;

FIG. 5 is a diagram schematically illustrating a cross section of a variable resistor according to an embodiment of the present invention in a state after repeated use;

FIG. 6 is a photograph substituted for a drawing, illustrating a state in which Reference Example 3 (fluorine-based lubricant) contains 40 weight % wear debris;

FIG. 7 is a photograph substituted for a drawing, illustrating a state in which Reference Example 4 (lubricant according to the present invention) contains 40 weight % wear debris;

FIG. 8 is a graph illustrating changes over time in output voltage and noise level in a state in which no problem is present;

FIG. 9 is a graph illustrating changes over time in output voltage and noise level in a state in which a problem is present; and

FIG. 10 is a graph illustrating changes in output noise level with an increase in the number of sliding cycles.

### DESCRIPTION OF THE PREFERRED EMBODIMENTS

Hereinafter, embodiments of the present invention will be described with reference to the attached drawings. In the drawings, the same members are denoted by the same reference numerals, and description thereof will be omitted as appropriate. In order to indicate positional relationships of members, reference coordinates are shown in the drawings as appropriate. In the reference coordinates, X-, Y-, and Z-directions are orthogonal to each other.

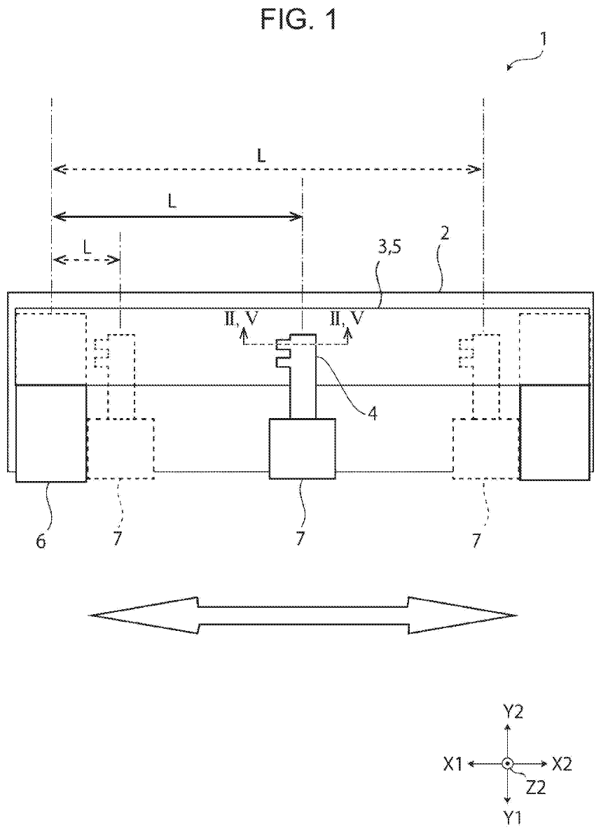

FIG. 1 is a plan view of a variable resistor 1 according to this embodiment, schematically illustrating a main part.

The variable resistor 1 includes a substrate 2, a resistance element 3, a conductive wiper 4 that slides on the surface of the resistance element 3, and a lubricant 5 applied to the surface of the resistance element 3.

The variable resistor 1 includes the substrate 2 on which the resistance element 3 is disposed, and the conductive wiper 4 as a sliding member that moves (slides) on the resistance element 3 in a state of being in contact with the surface thereof. When the conductive wiper 4 slides on the resistance element 3 containing a conductor and the relative position of the conductive wiper 4 in the resistance element 3 changes, the length L of a portion in the resistance element 3 through which electricity flows changes. In accordance with the length L of the portion in the resistance element 3 through which electricity flows, the electrical resistance value of a circuit connected to a terminal 6 of the resistance element 3 and a terminal 7 of the conductive wiper 4 varies. Thus, for example, the variable resistor 1 can detect the position of an analog joystick operatively connected to the conductive wiper 4 on the basis of a voltage that varies in accordance with the electrical resistance value.

The substrate 2 is one on the surface of which the resistance element 3 is formed, and is composed primarily of an insulating molded body such as a phenolic laminated substrate, a glass-containing epoxy substrate, a molded resin substrate, or a ceramic substrate.

The resistance element 3 contains carbon powder as a principal component and a binder resin that binds the carbon powder, and is disposed on the substrate 2. Normally, the resistance element 3 is formed using a resistive paste obtained by dispersing a conductive carbon powder such as carbon black in a binder resin dissolved in an appropriate solvent and, as necessary, further adding a solvent. A pattern having a predetermined shape is formed on the surface of the substrate 2 using the resistive paste through known screen printing or the like, thereby forming the resistance element 3. In the formation of the resistance element 3, as necessary, the solvent may be removed by drying, followed by firing.

A phenolic resin, a polyimide resin, or the like is used as the binder resin of the resistive paste. Heat resistance can be imparted to the resistance element 3 by a phenolic resin or a polyimide resin. In addition, by using a resin having a hydroxyl group such as a phenolic resin as the binder resin, wettability of the lubricant 5 having a polar functional group such as a hydroxyl group is improved, and the lubricant 5 readily and uniformly spreads on the resistance element 3. In order to impart wear resistance or the like, a filler such as carbon fiber or silicon oxide, or an additive such as a defoaming agent may be added to the resistive paste.

As illustrated in FIG. 1, in the case where the resistance element 3 is formed in an elongated shape, the conductive wiper 4 is slidably mounted to the substrate 2 so as to slide along the resistance element 3, thereby forming a slide-type variable resistor 1. The shape of the resistance element 3 is not limited to an elongated shape; for example, the resistance element 3 may be formed in an arc shape (horseshoe shape). In this case, the conductive wiper 4 is rotatably mounted to the substrate 2 so as to slide along the resistance element 3, thereby forming a rotary-type variable resistor 1.

The terminal 6 is provided, for example, by screen-printing a conductive paste such as silver onto the substrate 2 before the resistance element 3 is provided. Then, a pattern of the resistance element 3 is provided so as to cover the terminal 6, and the terminal 6 and the resistance element 3 are electrically connected.

The conductive wiper 4 is formed of a noble metal-based material that can maintain good contact with the resistance element 3 when the conductive wiper 4 repeatedly slides on the surface of the resistance element 3 over a long period of time. Specifically, a material obtained by applying gold plating or silver plating to the surface of phosphor bronze (a copper-zinc-nickel alloy), or an alloy of palladium, silver, platinum, or nickel may be used. In particular, when surface oxidation at high temperatures is a concern, it is desirable to use a noble metal alloy in order to maintain a stable contact state.

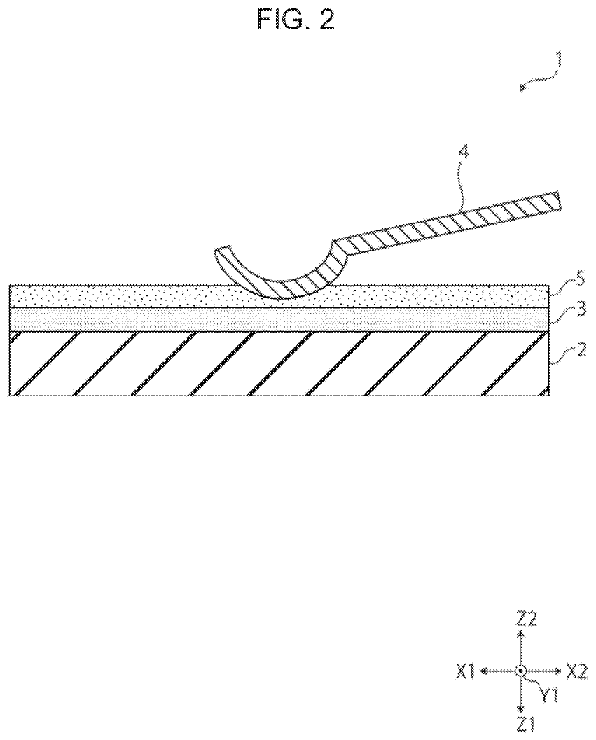

FIG. 2 is a diagram schematically illustrating a cross section of the variable resistor 1 illustrated in FIG. 1, taken along line II-II. As illustrated in FIG. 2, a lubricant 5 is applied to the surface of the resistance element 3 on the substrate 2 in order to improve wear resistance of the surface of the resistance element 3. In the related art, a fluorine-based lubricant has been used as the lubricant 5. Here, the fluorine-based lubricant refers to a substance in which half or more of the atoms bonded to a plurality of carbon atoms constituting the backbone are fluorine atoms and which has fluidity at room temperature (25 °C).

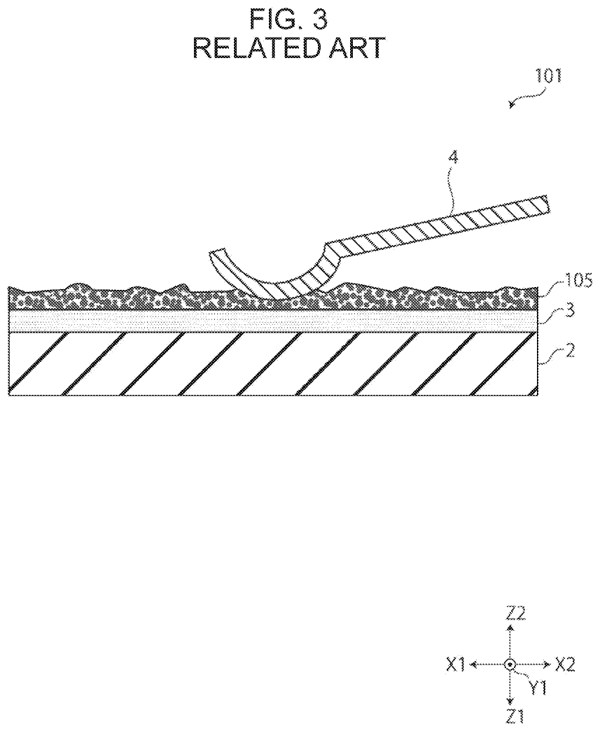

FIG. 3 is a diagram schematically illustrating a cross section of a known variable resistor 101 in a state after repeated use.

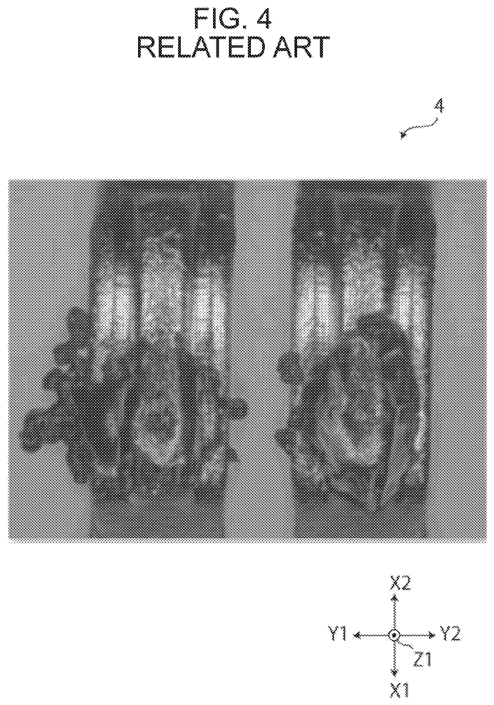

FIG. 4 is a photograph substituted for a drawing, illustrating the surface of the conductive wiper 4 in the known variable resistor 101 in which a problem has occurred in operation.

As illustrated in FIG. 3, as a result of repeated use, wear occurs when the conductive wiper 4 slides on the surface of the resistance element 3, and wear debris mainly derived from the resistance element 3 is generated. The wear debris mixes with the fluorine-based lubricant 105.

Since the wear debris is composed primarily of carbon powder contained in the resistance element 3 and does not have high affinity for the fluorine-based lubricant 105, the wear debris thickens by mixing with the fluorine-based lubricant 105, thereby forming a semi-solid insulating material. Then, as illustrated in FIG. 4, the thickened insulating material is caught in the sliding contact between the conductive wiper 4 and the resistance element 3, and causes output noise during sliding of the conductive wiper 4. Therefore, in the known variable resistor 101 using the fluorine-based lubricant 105, it has been found that it is difficult to extend sliding life.

Accordingly, in order to extend sliding life, the variable resistor 1 according to this embodiment uses, instead of the fluorine-based lubricant 105, a lubricant 5 having a molecular structure that enables the lubricant 5 to readily mix with wear debris of the resistance element 3 and that reduces the likelihood of formation of a thickened insulating material.

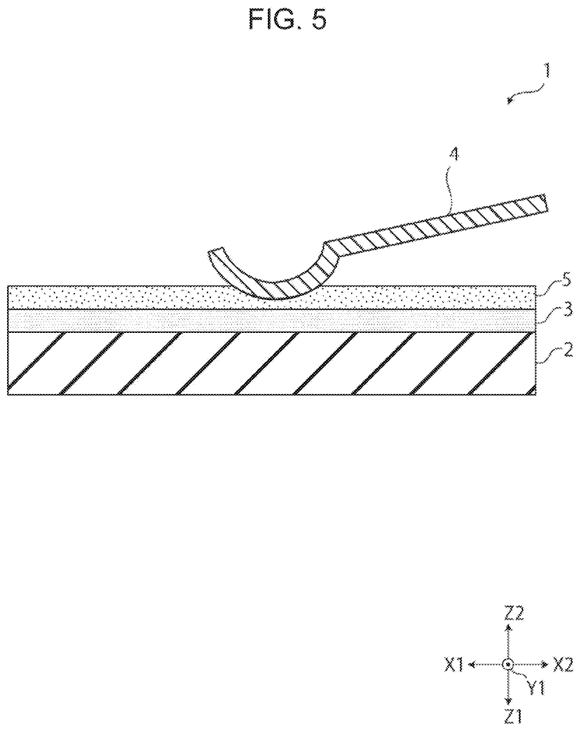

FIG. 5 is a schematic diagram illustrating a cross section of the variable resistor 1 taken along line V-V of FIG. 1 in a state after repeated use. By using the lubricant 5 having good affinity with wear debris of the resistance element 3, wear debris generated by repeated sliding of the conductive wiper 4 on the surface of the resistance element 3 can be dispersed in the lubricant 5.

That is, the lubricant 5 has a molecular structure including a chain structure in which a plurality of carbon atoms are covalently bonded to each other, the chain structure having polar functional groups located at one end and the other end thereof, the number of hydrogen atoms bonded to the carbon atoms being greater than the number of fluorine atoms bonded to the carbon atoms. Therefore, as compared with the known fluorine-based lubricant 105 in which the number of fluorine atoms bonded to a plurality of carbon atoms is greater than the number of hydrogen atoms bonded to the carbon atoms, the lubricant 5 has better affinity with wear debris of the resistance element 3 and is less likely to form a thickened insulating material. Accordingly, occurrence of output noise due to the thickened insulating material being caught in the sliding contact between the conductive wiper 4 and the resistance element 3 may be suppressed, and the sliding life of the variable resistor 1 may be extended.

When the resistance element 3 contains carbon powder and a phenolic resin, the surface of the resistance element 3 is composed of carbon atoms C, hydrogen atoms H, and oxygen atoms O. Therefore, affinity with the resistance element 3 and wear debris of the resistance element 3 is improved by using the lubricant 5 composed of carbon atoms C, hydrogen atoms H, and oxygen atoms O and having polar functional groups such as hydroxyl groups or carboxyl groups located at one end and the other end of the chain structure. Accordingly, from the viewpoint of affinity with wear debris, it is more preferable that the lubricant 5 does not contain fluorine atoms.

It is preferable that the chain structure of the lubricant 5 has an oxygen atom in an intermediate portion other than the polar functional groups located at one end and the other end. When the chain structure has an oxygen atom in the intermediate portion, affinity of the lubricant 5 with the resistance element 3 is further improved.

By using the lubricant 5 composed of the same elements (C, H, and O) as the resistance element 3 and having hydroxyl groups located at one end and the other end of the chain structure, the hydroxyl groups readily adsorbing onto wear debris of the resistance element 3, wear debris of the resistance element is readily wetted by the lubricant 5, thereby improving dispersibility of the wear debris in the lubricant 5. Accordingly, thickening of the lubricant 5 due to the wear debris may be suppressed, and the lubricant 5 may readily maintain fluidity. As a result, generation of a thickened insulating material due to repeated sliding of the conductive wiper 4 on the surface of the resistance element 3 may be suppressed. Even when an insulating material is generated, since the lubricant 5 contained in the insulating material has good affinity with the wear debris, the insulating material may be easily scraped away by the conductive wiper 4. Therefore, the insulating material is less likely to be caught in the contact portion between the resistance element 3 and the conductive wiper 4, and contact at the contact portion may be stabilized. Thus, wear debris of the resistance element does not aggregate or thicken, and occurrence of output noise when the conductive wiper 4 slides on the surface of the resistance element 3 may be suppressed, thereby making it possible to extend the sliding life of the variable resistor 1.

Examples of the lubricant 5 include polyalkylene glycol; a bonded product of two or more kinds of polyalkylene glycols; a bonded product of two or more kinds of polyalkylene glycols and an alkylene; polyalkylene glycol glyceryl ether in which polyalkylene glycols are bonded to three ends of glycerin; and polyalkylene glycol sorbitol ether. Examples of the polyalkylene glycol include polyethylene glycol, polypropylene glycol, and polybutylene glycol. Examples of the bonded product of two or more kinds of polyalkylene glycols include polyethylene glycol-polypropylene glycol block ether, polyethylene glycol-polybutylene glycol block ether, and polypropylene glycol-polybutylene glycol block ether. Among these, polybutylene glycol and polypropylene glycol glyceryl ether are preferable.

The molecular weight (weight-average molecular weight) of the lubricant 5 is preferably 300 to 3000, more preferably 500 to 2000, and further preferably 600 to 1800, from the viewpoint of extending the sliding life of the variable resistor 1.

The number of hydroxyl groups per 1000 molecular weight of the lubricant 5 is preferably about 2 or more and 4 or less, from the viewpoint of improving affinity with the resistance element 3.

The kinematic viscosity of the lubricant 5 at 45 °C is preferably about 30 to 70 centistokes (cst), from the viewpoint of extending the sliding life of the variable resistor 1.

The pour point of the lubricant 5 is preferably 0 °C or less, more preferably-10 °C or less, and further preferably −20 °C or less, from the viewpoint of stability under low-temperature conditions.

Examples of commercial products usable as the lubricant 5 include UNIOL (registered trademark) PB series, UNIOL (registered trademark) TG series, UNIOL (registered trademark) HS series, PLONON (registered trademark) series, UNIOX (registered trademark) series, and UNIOX (registered trademark) ST series, all manufactured by NOF Corporation.

The thickness of the lubricant 5 formed as a layer on the resistance element 3 is preferably 0.07 μm or more, more preferably 0.2 μm or more, and further preferably 0.8 μm or more, from the viewpoint of allowing the lubricant 5 to function and preventing deterioration of performance of the variable resistor 1. From the viewpoint of maintaining stable contact between the resistance element 3 and the conductive wiper 4, the thickness is preferably 3 μm or less.

Other lubricants or additives may be mixed with the lubricant 5 as necessary. However, the content of polyalkylene glycol and/or polyalkylene glycol glyceryl ether in the materials constituting the lubricant 5 is preferably 80% by weight or more, more preferably 100% by weight.

### EXAMPLES

### <Mixture of Wear Debris and Lubricating Oil>

After a resistive paste composed of carbon powder and a phenolic resin was fired to obtain a solid, the solid was pulverized for 100 hours using an automatic mortar grinder to obtain a fine powder. In this manner, a fine powder of the resistance element 3 having a particle size of less than 1 μm was prepared, the fine powder corresponding to wear debris generated by sliding of the conductive wiper 4 on the surface of the resistance element 3. The fine powder and the lubricant 5 were kneaded for 30 minutes using an automatic mortar grinder to prepare simulated thickened wear debris corresponding to wear debris of the resistance element 3 mixed with the lubricant 5, the wear debris being generated by sliding of the conductive wiper 4 on the surface of the resistance element 3. The state was evaluated.

FOMBLIN® ZDOL2000 having the structural formula below was used as a known fluorine-based lubricant 105 (see FIG. 3) to prepare simulated thickened wear debris containing 17% by weight, 24% by weight, and 40% by weight of the fine powder of the resistance element 3. The viscosities thereof were evaluated using a rotational viscometer. Table 1 shows the results (rotation speed of the viscometer: 100 rpm).

ZDOL2000 (two hydroxyl groups; weight-average molecular weight: 2000; kinematic viscosity: 28.7 cst (40 °C); pour point: −40 °C; number of hydroxyl groups per 1000 molecular weight: 1; FOMBLIN® ZDOL2000) with the following structural formula:

HOCH₂—CF₂O—(CF₂CF₂O)ₘ—(CF₂O)ₙ—CF₂—CH₂OH

where m and n are integers.

TABLE 1

| | Reference | Reference | Reference |
|---|---|---|---|
| | Example 1 | Example 2 | Example 3 |
| Lubricant | ZDOL2000 | ZDOL2000 | ZDOL2000 |
| Content (wt %) | 17 | 24 | 40 |
| Viscosity | 516 | 1,286 | ND* |
| (CPS, 100 rpm) | | | |

*It became crumbly (friable in texture) and measurement was not possible.

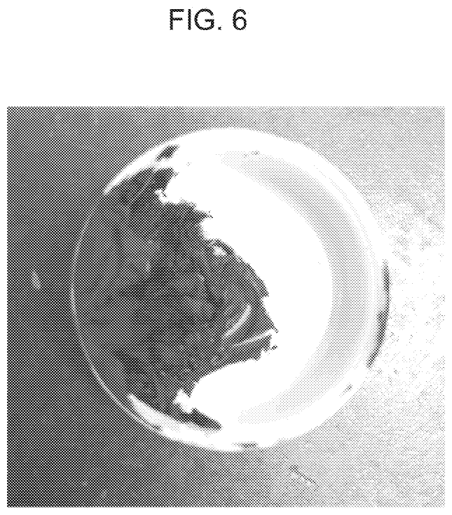

As shown in Table 1, in the case where the fluorine-based lubricant was used, the simulated thickened wear debris exhibited a smooth texture when the content of the fine powder was at a low level of about 24% by weight. However, when the fine powder content was at a high level of 40% by weight, as shown in FIG. 6, the mixture became crumbly, and the viscosity of the simulated thickened wear debris could not be measured. It can be said that this state reflects the state of a mixture of the lubricant and the wear debris in which output noise occurred in the variable resistor 1 (see FIG. 4).

Accordingly, instead of the fluorine-based lubricant, the following lubricants were used to prepare simulated thickened wear debris in which the content of the fine powder was 40% by weight. The viscosities were evaluated under the same conditions. Table 2 shows the results.
PB700 (polybutylene glycol; weight-average molecular weight: 700; hydroxyl groups at both ends; kinematic viscosity: 40 to 65 cst (40 °C); pour point: −40 °C; number of hydroxyl groups per 1000 molecular weight: 2.86; UNIOL (registered trademark) PB-700, manufactured by NOF Corporation) with the following structural formula:

HO—(C₄H₈O)ₐ—C₃H₆O—(C₄H₈O)_{b}—H
where a and b are integers, and a+b=9.
TG1000R (polypropylene glycol glyceryl ether; glycerin-like structure; weight-average molecular weight: 1,000; kinematic viscosity: 200 to 300 cst (25 °C); pour point: −25 °C; number of hydroxyl groups per 1000 molecular weight: 3; UNIOL (registered trademark) TG-1000R, manufactured by NOF Corporation) with the following structural formula:

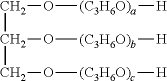

where a, b, and c are integers, and a+b+c=16.
MB7 (polyalkylene glycol derivative (water-insoluble type); hydroxyl group at one end; weight-average molecular weight: 700; kinematic viscosity: 32.8 cst (40 °C); pour point: −47.5 °C; number of hydroxyl groups per 1000 molecular weight: 1.43; UNILUBE (registered trademark) MB-7, manufactured by NOF Corporation) with the following structural formula:

C₄H₉—O—(C₃H₆O)₁₂—H
MB11 (polyalkylene glycol derivative (water-insoluble type); hydroxyl group at one end; weight-average molecular weight: 1,000; kinematic viscosity: 56.1 cst (40 °C); pour point: −42.5 °C; number of hydroxyl groups per 1000 molecular weight: 1; UNILUBE (registered trademark) MB-11, manufactured by NOF Corporation) with the following structural formula:

C₄H₉—O—(C₃H₆O)₁₇—H

TABLE 2

| | Reference | Reference | Reference | Reference |
|---|---|---|---|---|
| | Example 4 | Example 5 | Example 6 | Example 7 |
| Lubricant | PB700 | TG1000R | MB7 | MB11 |
| Content (wt %) | 40 | 40 | 40 | 40 |
| Viscosity | 2,262 | 3,993 | 1,778 | 2,786 |
| (CPS, 100 rpm) | | | | |

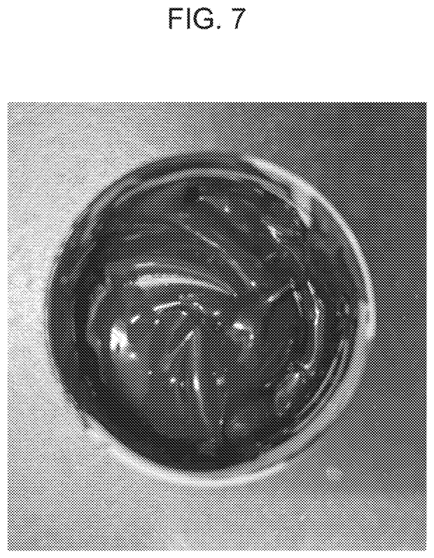

None of the simulated thickened wear debris became crumbly and friable in texture as in Reference Example 3; all exhibited a smooth texture similar to that of Reference Example 4 shown in FIG. 7. In all of Reference Examples 4 to 7, the simulated thickened wear debris was in a state in which viscosity measurement was possible. From these results, it was suggested that, by using a lubricant having good affinity with wear debris, as in Reference Examples 4 to 7 in which a mixture containing wear debris generated by sliding was reproduced, the generation of an insulating material composed of the wear debris and the lubricant, which causes output noise, may be suppressed. From the viewpoint of suppressing the generation of an insulating material composed of the wear debris and the lubricant, it is preferable to use a lubricant such that the viscosity at 100 rpm of the simulated thickened wear debris obtained by mixing the lubricant so that the content of the fine powder of the resistance element is 40% by weight is 4,000 CPS (mPa·s) or less.

### <Measurement of Sliding Life>

With respect to the variable resistor 1 using each of the lubricants of Reference Examples 3 to 6, the sliding life was measured by reciprocating the conductive wiper 4 on the surface of the resistance element 3 in the X-direction (see FIG. 1). In the measurement, the resistance element 3 having a total resistance of 5 kΩ was used, and the load of the conductive wiper 4 was set to 7 g per wiper.

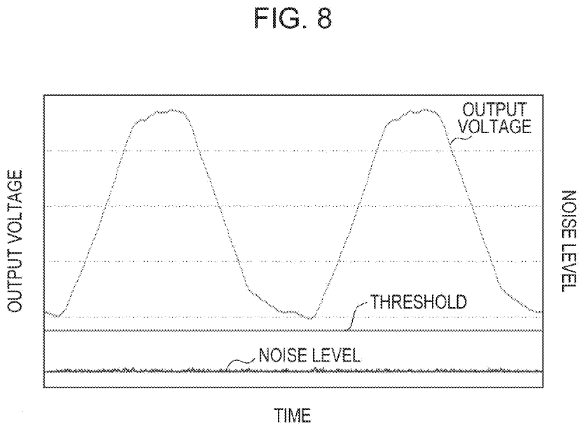

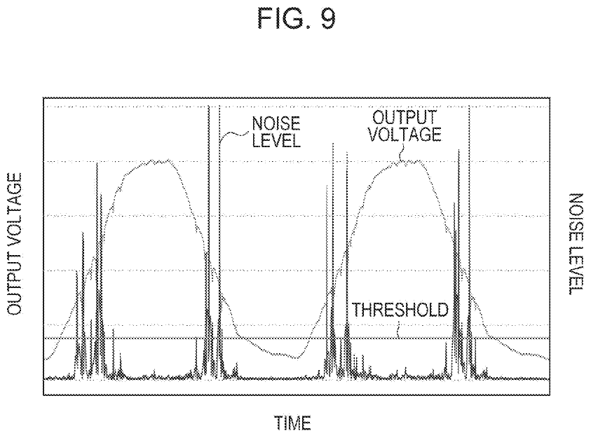

FIG. 8 is a graph illustrating the output voltage and the noise level over time when the conductive wiper 4 of the variable resistor 1 is reciprocated twice in a state in which no problem is present. FIG. 9 is a graph illustrating the output voltage and the noise level over time when the conductive wiper 4 of the variable resistor 1 is reciprocated twice in a state in which a problem is present.

At the start of the sliding life test, the output voltage of the variable resistor 1 changed smoothly as shown in FIG. 8. However, as the sliding life measurement test progressed, a mixture of the lubricant 5 and wear debris was generated, and jagged portions as shown in FIG. 9 appeared in the output voltage of the variable resistor 1. When the difference between the output voltage in the jagged portions and the smoothly changing output voltage, that is, the noise level, exceeds a predetermined threshold, a malfunction occurs in the operation of a controller using the variable resistor 1. The sliding life of the variable resistor 1 was evaluated on the basis of the number of sliding cycles at which output noise exceeding the threshold occurred in the output voltage of the variable resistor 1. Table 3 shows the measurement results.

TABLE 3

| | | | Comparative | Comparative | Comparative |
|---|---|---|---|---|---|
| | Example 1 | Example 2 | Example 1 | Example 2 | Example 3 |
| Lubricant | PB700 | TG1100R | ZDOL2000 | MB7 | MB11 |
| Number of hydroxyl groups | 2.86 | 3 | 1 | 1.43 | 1 |
| per 1000 molecular weight | | | | | |
| Number of samples | 2 | 1 | 3 | 1 | 2 |
| Number of sliding cycles | 0 | 0 | 1 | 0 | 0 |
| (×10⁴) ≤ 500 | | | | | |
| Number of sliding cycles | 0 | 0 | 2 | 1 | 2 |
| (×10⁴) > 500 and ≤1000 | | | | | |
| Number of sliding cycles | 1 | 1 | 0 | 0 | 0 |
| (×10⁴) > 1000 and ≤2000 | | | | | |
| Number of sliding cycles | 1 | 0 | 0 | 0 | 0 |
| (×10⁴) > 2000 | | | | | |

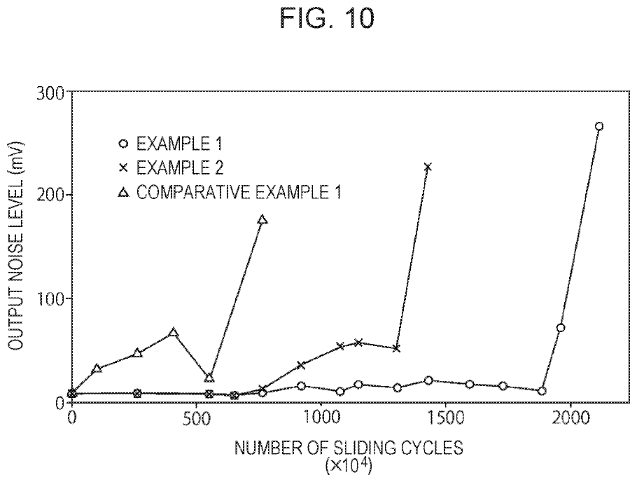

FIG. 10 is a graph illustrating changes in output noise level with an increase in the number of sliding cycles for Examples 1 and 2 and Comparative Example 1. In the graph of FIG. 10, for Example 1 and Comparative Example 1, the change in output noise level of the sample that exhibited the best result is shown.

As shown in Table 3 and FIG. 10, the variable resistors 1 of Examples 1 and 2 exhibited a greater number of sliding cycles before the noise level of the output voltage reached the threshold, as compared with the variable resistor 1 of Comparative Example 1 using a fluorine-based lubricant, thereby extending sliding life.

In the variable resistors 1 of Comparative Examples 2 and 3, a lubricant composed of carbon atoms C, hydrogen atoms H, and oxygen atoms O was used instead of a fluorine-based lubricant; however, as shown in Table 3, extension of sliding life comparable to that of Examples 1 and 2 could not be achieved. In Comparative Example 2, the number of hydroxyl groups per 1000 molecular weight was 1.43, and in Comparative Example 3, the number of hydroxyl groups per 1000 molecular weight was 1. Thus, the proportion of hydroxyl groups was smaller than that in Examples 1 and 2. Furthermore, there is also a structural difference in that, whereas Examples 1 and 2 had polar functional groups located at one end and the other end of the chain structure, Comparative Examples 2 and 3 had a polar functional group at only one end of the chain structure. From these results, it is considered that, for example, the number of hydroxyl groups per 1000 molecular weight and the presence or absence of polar functional group at the ends of the chain structure are also related to the extension of the sliding life of the variable resistor 1. From the viewpoint of extending the sliding life of the variable resistor 1, the number of hydroxyl groups per 1000 molecular weight is preferably 1.5 or more, more preferably 2.0 or more. In addition, it can be said that a lubricant having hydroxyl groups as polar functional groups located at one end and the other end of the chain structure is preferable.

The embodiments disclosed in the present specification are illustrative in all respects, and are not intended to limit the present invention. The scope of the present invention is indicated not by the description of the embodiments described above alone but by the claims. It is intended that all modifications falling within the scope of the claims and their equivalents be included within the scope of the present invention.

The present invention can be used as a variable resistor for a controller of a game device or the like.

What is claimed is:

1. A variable resistor comprising:
a substrate;
a resistance element disposed on a surface of the substrate, the resistance element including carbon powder and a binder resin that binds the carbon powder;
a conductive wiper that slides on a surface of the resistance element; and
a lubricant applied to the surface of the resistance element,
wherein the lubricant has a molecular structure including a chain structure including a plurality of carbon atoms covalently bonded to each other, the chain structure having polar functional groups located at one end and the other end thereof, a number of hydrogen atoms bonded to the plurality of carbon atoms being greater than a number of fluorine atoms bonded to the plurality of carbon atoms.

2. The variable resistor according to claim 1,
wherein the polar functional groups are hydroxyl groups.

3. The variable resistor according to claim 1,
wherein the chain structure has an oxygen atom in an intermediate portion other than the polar functional groups located at one end and the other end.

4. The variable resistor according to claim 1,
wherein the lubricant is polyalkylene glycol or a bonded product of a plurality of polyalkylene glycols.

5. The variable resistor according to claim 1,
wherein the lubricant is polybutylene glycol.

6. The variable resistor according to claim 1,
wherein the lubricant is polyalkylene glycol glyceryl ether.

7. The variable resistor according to claim 1,
wherein the lubricant is polypropylene glycol glyceryl ether.

8. The variable resistor according to claim 1,
wherein the binder resin has a hydroxyl group.

9. The variable resistor according to claim 8,
wherein the binder resin is a phenolic resin.
